(19) United States
(12) Patent Application Publication
(10) Pub. No.: US 2008/0258870 A1
(43) Pub. Date: Oct. 23, 2008

(54) REMOTE CONTROL SYSTEM AND METHOD

(75) Inventor: Masahiro Sugiura, Takahama-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/102,350

(22) Filed: Apr. 14, 2008

(30) Foreign Application Priority Data
Apr. 19, 2007 (JP) 2007-110620

(51) Int. Cl. G08B 5/22

(52) U.S. Cl. 340/7.23

(57) ABSTRACT

A vehicle remote control system includes a portable device for transmitting a control request command and an in-vehicle device for executing various kinds of vehicle control in accordance with the control request command. During execution of the control by the in-vehicle device, the portable device is set to a standby state under which a UHF transmitter and a UHF receiver are put in a standby or rest state, thereby reducing power consumption. After a standby time elapses, the portable device repeats request command transmission and reply reception until a reply is received from the in-vehicle device.

### CROSS REFERENCE TO RELATED APPLICATION

This application is based on and incorporates herein by reference Japanese Patent Application No. 2007-110620 filed on Apr. 19, 2007.

### FIELD OF THE INVENTION

The present invention relates to a remote control system and method, and a portable device and a fixed device for the remote control system.

### BACKGROUND OF THE INVENTION

A remote control system used for a vehicle as a vehicle remote control system has a fixed in-vehicle device mounted in a vehicle and a portable device carried by a user of the vehicle. This type of vehicle remote control system is constructed so that lock and unlock of doors, start of an engine, etc. can be remotely controlled without operating a mechanical type key in the neighborhood of a vehicle by operating a portable device at a location away from the vehicle.

Furthermore, in this type of vehicle remote control system, a technique for performing communication by switching plural channels having different frequencies to any one channel are proposed (for example, JP 4-315681A). In this proposal, the user operates a switch to switch the plural channels to any one channel, whereby the channel to be used at the communication time can be changed.

Still furthermore, it is also proposed to switch the communication frequency when noise is detected in advance and thus it is determined that interference is caused (for example, EP 1,362,753A).

In these vehicle remote control systems, if a control request signal requesting predetermined control in a vehicle is transmitted from the portable device to the in-vehicle device and then information concerning a control result is transmitted from the in-vehicle device to the portable device, the user can check the control result at the portable device.

However, the time required for the control at the in-vehicle device varies in accordance with the content of the control or the state of control target equipment. Therefore, if the information concerning the control result is transmitted from the in-vehicle device to the portable device immediately at the time point when the control at the in-vehicle device is completed, the following problem occurs.

First, at the portable device, the time point at which information is transmitted from the in-vehicle device cannot be accurately grasped at the portable device. Therefore, a method of setting the reception circuit at the portable device to an active state to prepare for reception of information immediately after a control request signal is transmitted from the portable device to the in-vehicle device must be adopted so that the portable device can accurately receive information from the in-vehicle device.

However, in this case, the reception circuit at the portable device is set to the active state although the control at the in-vehicle device is not actually completed, and thus the time period when electric power is needlessly wasted at the portable device becomes long, so that the lifetime of a battery is shortened by the amount corresponding to the wasting of power.

Furthermore, even when it is requested to execute some processing at the portable device before the reception circuit is set to the active state, there is little time to spare for the execution of such processing.

As a countermeasure to the above problem, the time point at which the reception circuit of the portable device is set to the active state can be properly delayed in consideration of the time required for the control at the in-vehicle device. However, in this case, when the in-vehicle device transmits information more in a short time than expected, the portable device may fail to receive the information concerned.

### SUMMARY OF THE INVENTION

The present invention therefore has an object to provide a remote control system and method, in which information concerning a control result can be transmitted from a fixed device to a portable device, power consumption at the portable device can be suppressed and a time to spare for execution of various kinds of processing at the portable device can be secured at the portable device before the portable device receives information from the fixed device.

In order to attain the above object, in a remote control system, when a control request signal corresponding to an operation executed by a user is transmitted from a portable device to a fixed device, the fixed device executes predetermined control defined in correspondence to the control request signal. The portable device transmits a reply (acknowledge) request signal to the fixed device, when a predetermined standby time elapses after the control request signal is transmitted.

With the transmission and reception of this reply request signal as a trigger, the fixed device transmits information concerning the execution result of the control executed by a control unit when a transmission time point determined in accordance with a reception time of the reply request signal has arrived. The portable device receives a reply signal transmitted from the fixed device when a reception time point determined in accordance with a transmission time of the reply request signal has come.

According to the above construction, the portable device can transmit the reply request signal after a sufficient standby time elapses in consideration of the time required for the control at the fixed device, and thereafter the portable device can receive a reply from the fixed device in a short time.

Accordingly, it is unnecessary for the portable device to continue to wait for a reply to which a return time point from the fixed device is unclear unlike a system in which a transmission time point of information concerning a control result from the in-vehicle device to the portable device is determined by only the convenience of the fixed device. Accordingly, the power consumption at the portable device can be reduced, and the portable device can secure a time to spare for execution of various kinds of processing before receiving information from the fixed device.

### BRIEF DESCRIPTION OF THE DRAWINGS

The above and other objects, features and advantages of the present invention will become more apparent from the following detailed description made with reference to the accompanying drawings. In the drawings:

FIG. 1A is a block diagram showing a vehicle remote control system according to an embodiment of the present invention;

FIG. 1B is a block diagram showing a UHF transmitter and receiver circuit used in an in-vehicle device of the embodiment;

FIG. 2 is a flowchart showing processing executed by a portable device of the embodiment;

FIG. 3 is a flowchart showing processing executed by the in-vehicle device of the embodiment;

FIG. 4 is a timing diagram showing an example of a communication state when the processing at the in-vehicle device and the processing at the portable device are executed; and

FIG. 5 is a block diagram showing a vehicle remote control system according to a modification of the embodiment.

### DETAILED DESCRIPTION OF PREFERRED EMBODIMENT

According to an embodiment of the present invention, a remote control system is configured as a vehicle remote control system. This system has, as its main functions, a remote keyless entry function of locking and unlocking doors of a vehicle in accordance with a button operation at a portable device, and a remote engine start function of executing start of an engine of the vehicle. In this embodiment, the system also has a passive entry function of executing the control of unlock, etc. of doors when a specific portable device carried by a registered user of a vehicle enters a wireless communication area around the vehicle concerned.

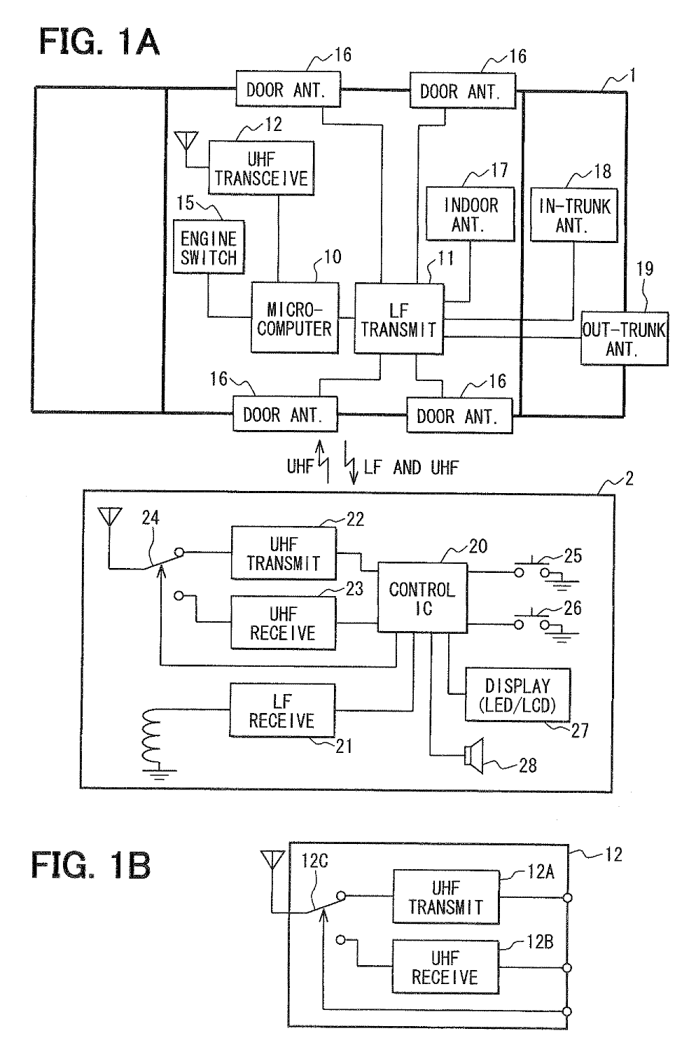

As shown in FIG. 1A, the vehicle remote control system is constructed with an in-vehicle device 1 and a portable device 2. The in-vehicle device 1 is fixedly mounted as a fixed device in a vehicle, which is a control object. The portable device 2 is carried by a user such as a vehicle driver. The in-vehicle device 1 is equipped with a microcomputer 10, an LF transmitter 11, a UHF transceiver (transmitter and receiver) 12, an engine switch 15, a door antenna 16, an indoor antenna 17, an in-trunk antenna 18, an out-trunk antenna 19, etc.

The LF transmitter 11 is provided and used for the passive entry function, and it transmits a radio signal to the portable device 2 with electric waves in the LF (low frequency; long wave) band. The radio signal transmitted from the LF transmitter is set to reach only the inside of each of limited communication areas of the door antennas 16 located at four positions, the indoor antenna 17, the in-trunk antenna 18 and the out-trunk antenna 19.

The UHF transceiver 12 transmits and receives a radio signal to and from the portable device 2 with electrical waves in the UHF (ultra high frequency) band. More specifically, as shown in FIG. 1B, the UHF transceiver 12 is constructed with a UHF transmitter 12A, a UHF receiver 12B, a transmission and reception change-over switch 12C, etc.

The UHF transmitter 12A transmits a radio signal to the portable device 2 with electric waves in the UHF band. The UHF receiver 12B receives a radio signal transmitted with electric waves in the UHF band from the portable device 2.

The transmission and reception change-over switch 12C is a switch whose switching operation is controlled by the microcomputer 10, and it is used to perform the switching operation between the transmission based on the UHF transmitter 12A and the reception based on the UHF receiver 12B.

The transmission and the reception are switched to each other by the transmission and reception change-over switch 12C to perform half-duplex communication. However, other constructions may be adopted insofar as transmission and reception can be performed. For example, transmission and reception may be performed by full-duplex communication by adopting a circulator in place of the transmission and reception change-over switch 12C, for example.

The engine switch 15 is operated by a user when the engine is started. When it is detected from a signal from the engine switch 15 that the user operates the engine switch 15, the microcomputer 10 checks whether the engine is under the state that it is allowed to be started. If the engine is allowed to be started, an engine start signal is transmitted from the microcomputer 10 to an engine control system.

The portable device 2 is equipped with a control IC 20, a LF receiver 21, a UHF transmitter 22, a UHF receiver 23, a transmission and reception change-over switch 24, push switches 25, 26, a display unit 27, a buzzer 28, etc.

The LF receiver 21 is used for the passive entry function, and it receives a radio signal transmitted with electric waves in the LF band from the in-vehicle device 1. The UHF transmitter 22 transmits a radio signal to the in-vehicle device 1 with electric waves in the UHF band. The UHF receiver 23 receives a radio signal transmitted with electric waves in the UHF band from the in-vehicle device 1.

The transmission and reception change-over switch 24 is a switch whose switching operation is controlled by the control IC 20, and the transmission and reception change-over switch 24 performs the switching operation between the transmission based on the UHF transmitter 22 and the reception based on the UHF receiver 23. A circulator may be adopted in place of the transmission and reception change-over switch 24 as in the case of the transmission and reception change-over switch 12C.

The push switches 25, 26 are prepared as keys serving as a trigger for utilizing the remote keyless entry function and the remote engine start function. Any operating method of the push switches 25, 26 may be adopted. In this embodiment, doors are locked when the push switch 25 is operated by one-push. Furthermore, the door is unlocked when the push switch 26 is operated by one-push. When the door is locked and unlocked, the information concerning whether the door is locked or unlocked is transmitted from the in-vehicle device 1 to the portable device 2. These vehicle information is displayed on the display unit 27, and also reported (notified) by the buzzer 28.

Furthermore, in the case of this embodiment, when the push switch 25 is continued to be pressed for a long time, the engine is started. When the engine is started, information such as the remaining amount of fuel, the vehicle interior temperature, the vehicle exterior temperature, rainfall information, etc. are transmitted from the in-vehicle device 1 to the portable device 2. These information is displayed on the display unit 27.

The display unit 27 comprises LCD and LED, and it functions as an alarm unit. The buzzer 28 also functions as an alarm unit. That is, in this embodiment, both the display unit 27 (LED) and the buzzer 28 are used as the alarm units.

### [Summary of Passive Entry Function]

Next, the summary of the passive entry function will be described.

The respective parts of the in-vehicle device 1 are controlled to be actuated by the microcomputer 10, and the LF transmitter 11 periodically transmits a transmission request signal under the control of the microcomputer 10. The respective parts of the portable device 2 are controlled to be actuated by the control IC 20. When the portable device 2 enters a wireless communication area in which the portable device 2 can receive the transmission request signal from the LF transmitter 11, the LF receiver 21 receives the transmission request signal.

Signal communication using electric waves in the LF band is carried out between the LF transmitter 11 and the LF receiver 21. This is carried out to limit the detection area of the portable device 2 to the periphery of the vehicle. Particularly, by transmitting signals from the door antennas 16, the vehicle interior antenna 17, the in-trunk antenna 18, the out-trunk antenna 19, etc., the detection area can be limited to the neighborhood of the door, the inside of the vehicle compartment, the inside of the trunk, the outside of the trunk, etc. Accordingly, it is detected where the portable device 2 is. For example, when the portable device 2 is left behind, the portable device 2 can be prevented from being confined.

When the LF receiver 21 receives the transmission request signal from the in-vehicle device 1, the UHF transmitter 22 transmits a reply signal containing an identification code (ID) indicating that the portable device 2 is the one assigned to the vehicle. At the in-vehicle device 1, the UHF transceiver 12 receives the reply signal from the portable device 2.

Signal transmission using electric waves in the UHF band is carried out between the UHF transmitter 22 and the UHF transceiver 12. This is because the communication distance can be properly ensured even when the output level of the portable device 2 is relatively low. Thus, the reply signal can be surely transmitted to the in-vehicle device 1.

When the UHF transceiver 12 receives the reply signal from the portable device 2, the microcomputer 10 at the in-vehicle device 1 makes an authentication check as to whether a code contained in the replay signal is coincident with a code stored in the microcomputer 10. If the check result indicates that both codes are coincident with each other, the door is set to an unlock-permitted state.

In the subsequent processing, known control of this type of vehicle remote control system is executed. For example, when it is detected on the basis of a signal from a touch sensor (not shown) provided on the door knob at the outside of the driver's seat door that a person touches the door knob under the unlock-permitted state of the door, the microcomputer 10 transmits an unlock signal to the door control system. As a result, a door lock motor (not shown) is driven, and all the doors are set to the door unlock state. Furthermore, when the engine is set to a start-permitted state, various kinds of control are performed.

Next, the remote keyless entry function and the remote engine start function will be briefly described.

The respective parts of the in-vehicle device 1 are controlled to be actuated by the microcomputer 10, and the UHF transceiver 12 is allowed to periodically receive a control request signal from the portable device 2 under the control of the microcomputer 10. Furthermore, when the user operates the push switch 25, 26 in the portable device 2, the respective parts of the portable device 2 are controlled to be actuated by the control IC 20, and the portable device 2 transmits a control request signal from the UHF transmitter 22, and the UHF transceiver 12 receives the control request signal concerned.

The signal communication using electric waves in the UHF band is carried out between the UHF transmitter 22 and the UHF transceiver 12. Therefore, the communication distance can be properly made even when the output level of the portable device 2 is relatively weak, and the control request signal can be surely transmitted to the in-vehicle device 1.

Furthermore, the communication is carried out by using two channels as a countermeasure to failure in the communication between the UHF transmitter 22 and the UHF transceiver 12 due to interfering waves. The control request signal may be transmitted over plural times (four times) by using each of these channels.

When the user operates the push switch 25, 26, the UHF transmitter 22 transmits a control request signal containing a control code representing the control content corresponding to the operation (for example, lock of doors, unlock of doors, start of the engine) and an ID code representing that the portable device 2 is a portable device assigned to the vehicle. At the in-vehicle device 1, the UHF transceiver 12 receives the control request signal from the portable device 2.

When the UHF transceiver 12 receives the control request signal from the portable device 2, the microcomputer 10 at the in-vehicle device 1 makes an authentication check as to whether the ID code contained in the control request signal is coincident with a code stored in the microcomputer 10. If it is determined that both codes are coincident with each other, the control indicated by the control code is executed. For example, if the control code is a code indicating the unlock of doors, the unlock control of the doors is executed.

After the above control is executed, the in-vehicle device 1 prepares for information to be returned as a reply signal to the portable device 2. The information to be prepared for is changed in accordance with the control executed by the in-vehicle device 1. For example, if the lock control of the doors is executed, information representing whether the doors could be normally locked is returned as a reply signal to the portable device 2. Furthermore, if the unlock control of the doors is executed, information representing whether the doors could be normally unlocked is returned to the portable device 2 as a reply signal.

Furthermore, when the engine start is controlled, the information representing whether the engine could be normally started is returned to the portable device 2 as a reply signal. The information of this replay signal may also include the remaining amount of fuel, the vehicle interior temperature, the vehicle exterior temperature, the rainfall information, etc. That is, various accompanying information is transmitted to the portable device 2 in addition to the engine start result only when the engine start is controlled.

The information concerning the remaining amount of fuel can be acquired through the communication between the microcomputer 10 and ECU (not shown) of the engine control system. Likewise, the information on the vehicle interior temperature and the vehicle exterior temperature can be obtained from ECU of an air conditioning control system. The rainfall information can be obtained from ECU of a wiper control system. However, the specific method of acquiring these information is arbitrary, and the communication with another ECU is not necessarily required. For example, if a fuel sensor, a temperature sensor, a rainfall sensor; etc. which are dedicated to the microcomputer 10 are provided, the communication with another ECU is not required.

After the information for the reply signal is prepared, the UHF transceiver 12 is allowed to receive the reply request signal from the portable device 2 in the in-vehicle device 1. Furthermore, after transmitting the control request signal, the portable device 2 waits until a predetermined standby time elapses, and then transmits the replay request signal.

The portable device 2 transmits the reply request signal after the predetermined standby time elapses, because the in-vehicle device 1 requires a certain time to execute various kinds of control and prepare for information as a reply signal. The time required for the in-vehicle device 1 to execute various kinds of control and prepare for information as a reply signal is dispersed to some extent. However, it can be estimated in advance how long the required time is at the shortest and at the longest.

Accordingly, if the reply request signal is transmitted at the time point when the estimated time elapses, the reply request signal can be prevented from being transmitted excessively early at the stage that the in-vehicle device 1 cannot receive the reply request signal.

The reply request signal transmitted from the portable device 2 is received by the UHF transceiver 12 in the in-vehicle device 1. When the UHF transceiver 12 receives the reply request signal from the portable device 2, the in-vehicle device 1 transmits the information representing the result of the control executed on the basis of the previously received control request signal as a reply signal from the UHF transceiver 12.

The reply signal containing various kinds of information is received by the UHF receiver 23 of the portable device 2. Then, the information concerned is displayed on the display unit 27. Accordingly, by watching the display content of the display unit 27, the user can know whether the doors could be normally locked, whether the doors could be normally unlocked, whether the engine could be normally started or the like.

Furthermore, at the start time of the engine, the information such as the fuel remaining amount, the vehicle interior temperature, the vehicle exterior temperature, the rainfall information, etc. are also displayed. Therefore, it is possible to make various determinations as to whether fuel should be supplemented, whether measures to cold should be taken, whether the user should go out with an umbrella, etc.

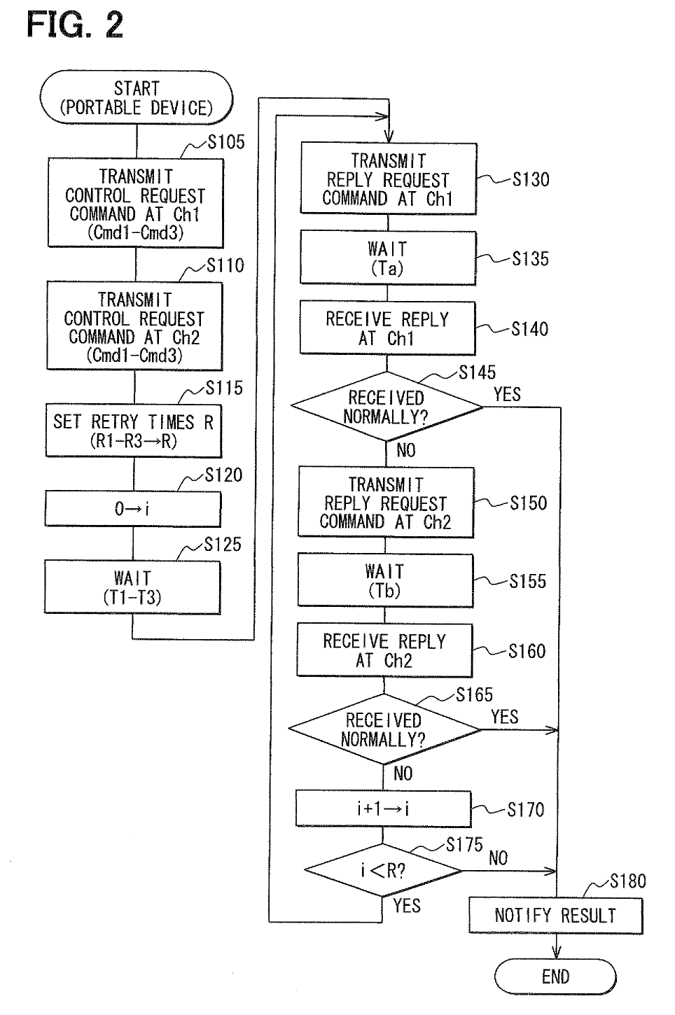

Next, the portable-device processing executed by the portable device 2 when the remote keyless entry function or the remote engine start function is utilized will be described with reference to FIG. 2. This portable-device processing is the processing executed when the user operates the push switch 25, 26 to lock or unlock doors or start the engine.

When the portable-device processing is started, the portable device 2 first transmits a control request command at Ch1 out of two channels (Ch1, Ch2) (S105). In the processing of S105, data containing a bit train as a control request command in each frame are sequentially and repetitively transmitted by the amount corresponding to four frames. The control request command specifies predetermined control such as door lock or unlock, engine start, etc. to be performed in the vehicle.

The repetitive transmission of the four frames is performed because the in-vehicle device 1 is not set to a state where it can receive the control request command at all times, but a state where the in-vehicle device 1 can receive the control request command (reception-possible state) and a state where the in-vehicle device 1 cannot receive the control request command (reception-impossible state) are intermittently repeated.

More specifically, the in-vehicle device 1 repeats the operation of normally setting the state thereof to the reception-possible state for only a short period and shifting the reception-possible state to the reception-impossible state to reduce power consumption when reception of the control request command is not started within such a limited period. When the reception of the control request command is started within the short period, the reception is continued until the reception of the control request command is completed.

On the basis of the assumption described above, the repetitive transmission period of the four frames at the portable device 2 is optimized on the basis of the relationship with the standby period for which the in-vehicle device 1 is set to the reception-impossible state. Specifically the vehicle remote control system is optimally designed on the basis of the data rate, the frame length (data length), the standby period (intermittent reception period) of the in-vehicle device 1, etc. so that data of at least one frame can be received from the head thereof just before the in-vehicle device 1 is set to the reception-impossible state or even when reception is started just after the in-vehicle device 1 is set to the reception-possible state.

Furthermore, in the processing of S105, any one of a command Cmd1 for requesting the lock of the doors, a command Cmd2 for requesting the unlock of the doors and a command Cmd3 for requesting the start of the engine is transmitted as the control request command. It is determined in accordance with the operation (the operation at the push switch 25, 26) as a trigger for starting the portable-device processing which one of the commands is transmitted.

When the processing of S105 is finished, the portable device 2 transmits a control request command at Ch2 (S110). The processing of S110 is the same as the processing of S105 except for use of Ch2. That is, it is the same as the processing of S105 that the data containing a bit train as a control request command are sequentially and repetitively transmitted by the amount corresponding to four frames. Furthermore, it is also the same as the processing of S105 that any one of commands Cmd1 to Cmd3 is transmitted in accordance with an operation as a trigger for starting the portable-device processing (the operation at the push switch 25, 26).

Subsequently, the portable device 2 sets the retry times (number of retry) R (S115). The retry times R corresponds to the repetitive frequency of the processing of S130 to S175 described later, and this number is varied in accordance with which one of the commands Cmd1 to Cmd3 is transmitted. Specifically, the values R1 to R3 of the retry frequencies corresponding to the commands Cmd1 to Cmd3 respectively are stored in ROM of the control IC 20 in advance. In the processing of S115, any one of the values R1 to R3 is set to the retry times R in accordance with the operation as a trigger for starting the portable-device processing (the operation at the push switch 25, 26).

When the retry times R is variably set as described above, the repetitive frequency can be adjusted so as to be set to a relatively small value for the command Cmd1 requesting the lock of the doors and the command Cmd2 requesting the unlock of the doors, and also so as to be set to a relatively large value for the command Cmd3 requesting the start of the engine.

When the processing of S115 is finished, the portable device 2 clears a loop counter (count) i (S120) to zero, and waits until a predetermined standby time elapses (S125). The standby time in the processing of S125 is varied in accordance with which one of the commands Cmd1 to Cmd3 is transmitted. Specifically, the standby times T1 to T3 corresponding to the commands Cmd1 to Cmd3 respectively are stored in ROM of the control IC 20 in advance.

In the processing of S125, any one of the standby times T1 to T3 is selected in accordance with the operation (the operation at the push switch 25, 26) as a trigger for starting the portable-device processing, and the processing is awaited until the selected standby time (one of T1 to T3) elapses. During this standby period, the UHF transmitter 22 and the UHF receiver 23 are set to a resting state, whereby the power consumption at the portable device 2 is reduced.

When the processing of S125 is completed as a result of the lapse of a predetermined time (one of the selected standby times T1 to T3), the portable device 2 transmits a reply request command to the in-vehicle device 1 at Ch1 (S130). The reply request command transmitted at Ch1 is a command for requesting the in-vehicle device 1 to transmit a reply to the control request command transmitted in the processing of S105.

Subsequently, the portable device 2 waits by only a predetermined standby time Ta (S135). The standby time Ta in the processing of S135 is set to the shortest time or less between the transmission time of the reply request command to the in-vehicle device 1 till the return time of the reply from the in-vehicle device 1. However, it is normal that the shortest time is not excessively long, and thus the processing of S135 may be eliminated if it is unnecessary.

Subsequently, the portable device 2 tries to receive a reply from the in-vehicle device 1 (S140). In the processing of S140, when the in-vehicle device 1 transmits the reply at Ch1, the portable device 2 receives the reply from the in-vehicle device 1. However, under such an environment that interfering waves having the same frequency as Ch1 are present, the reception at Ch1 may fail. Furthermore, under such an environment that interfering waves having the same frequency as Ch1 are present, the control request command which may be originally transmitted at Ch1 in the processing of S105 does not reach the in-vehicle device 1. In this case, no reply is returned from the in-vehicle device 1, and thus the reception at Ch1 fails.

Therefore, in the processing of S140, the portable device 2 tries to receive the reply from the in-vehicle device 1 at Ch1 for only a predetermined time, and then checks whether the reply could be normally received (S145). In the processing of S145, if the reply could not be normally received (S145: NO), the portable device 2 further transmits a reply request command to the in-vehicle device 1 at Ch2 (S150). The reply request command transmitted at Ch2 is a command for requesting the in-vehicle device 1 to transmit the reply corresponding to the control request command transmitted in the processing of S110.

Subsequently, the portable device 2 waits for only a predetermined standby time Tb (S155). The standby time Tb in the processing of S155 is set to the shortest time or less between the transmission time of the reply request command to the in-vehicle device 1 and the return time of the reply from the in-vehicle device 1 as in the case of the processing of S135. It is normal that this shortest time is not excessively long, and thus the processing of S155 may be eliminated as in the case of the processing of S135.

Subsequently, the portable device 2 tries to receive the reply from the in-vehicle device 1 at Ch2 (S160). If the processing of S150 to S160 as described above is executed, even when the control request command which ought to be transmitted at Ch1 by the processing of S105 does not reach the in-vehicle device 1 under the environment that interfering waves having the same frequency as Ch1 are present, a reply to the control request command transmitted at Ch2 may be received by the processing of Silo. That is, in the processing of S160, when the in-vehicle device 1 transmits a reply at Ch2, the reply from the in-vehicle device 1 may be received.

However, under the environment that the interfering waves having the same frequency as Ch2 come, the reception at Ch2 may fail. Furthermore, under the environment that the interfering waves having the same frequency as Ch2, there is a probability that the control request command which ought to be originally transmitted at Ch2 by the processing of S110 does not reach the in-vehicle device 1. In this case, no reply is returned from the in-vehicle device 1 and thus the reception at Ch2 fails.

Therefore, in the processing of S160, the portable device 2 tries to receive a reply from the in-vehicle device 1 at Ch2 for only a predetermined time and then checks whether the reply could be normally received as in the case of the processing of S140 (S165). If the normal reception could not be performed in the processing of S165 (S165: NO), the portable device 2 adds “1” to the loop counter i (S170), and compares the loop counter i with the retry times R (S175).

If i<R in the processing of S175 (S175: YES), the processing returns to the processing of S130, whereby the processing of S130 to S175 is repeated. If it is determined in the processing of S145 or the processing of S165 that the reply is normally received during the above repetitive processing (S145: YES or S165: YES), the control result is reported to the user (S180), and the portable-device processing is finished.

In the processing of S180, the information concerning the control result contained in the received reply is displayed on the display unit 27 or the buzzer 28 is actuated to transmit sounds if necessary, whereby the result is reported. Furthermore, the information contained in the reply received in the processing of S140 or S160 is changed in accordance with the control request command transmitted in S105 and S110 (any one of the commands Cmd1 to Cmd3). Therefore, the information to be notified to the user in the processing of S180 is also changed in accordance with the control request command (any one of the commands Cmd1 to Cmd3).

Specifically, when the control request command is the command Cmd1 for requesting the lock of doors, the information representing whether the doors could be normally locked is reported in the processing of S180. When the control request command is the command Cmd2 for requesting the unlock of the doors, the information representing whether the doors could be normally unlocked is reported in the processing of S180.

Furthermore, when the control request command is the command Cmd3 for requesting the start of the engine, the information representing whether the engine could be normally started is reported in the processing of S180, and also the fuel remaining amount, the vehicle interior temperature, the vehicle exterior temperature, the rainfall information, etc. are displayed.

As described above, the reply reception at Ch1 and the reply reception at Ch2 are tried while the processing of S130 to S175 is executed once. If the reply reception at any one of the channels Ch1 and Ch2 succeeds, the information concerning the control result containing the received reply is reported. Furthermore, when the reply receptions at both the channels fail, the processing of S130 to S175 is repeated by only the times set in the retry times R to re-try the reply reception at Ch1 and the reply reception at Ch2.

If such a retry is repeated, the reply reception at either channel may succeed at some retry time even when the reply receptions at both the channels fail due to extemporaneous interring waves. Or, even when the reply cannot be immediately returned because it takes much time to control at the in-vehicle device 1, the reply may be transmitted from the in-vehicle device 1 to the portable device 2 at some later retry time.

Even when the reply reception continues to fail at both channels Ch1 and Ch2 in spite of the repetitive retry as described above, it is finally determined in the processing of S175 that i≧R is satisfied (S175: NO). In this case, the portable device 2 notifies a result indicating that the reply reception fails, and the portable-device processing is finished.

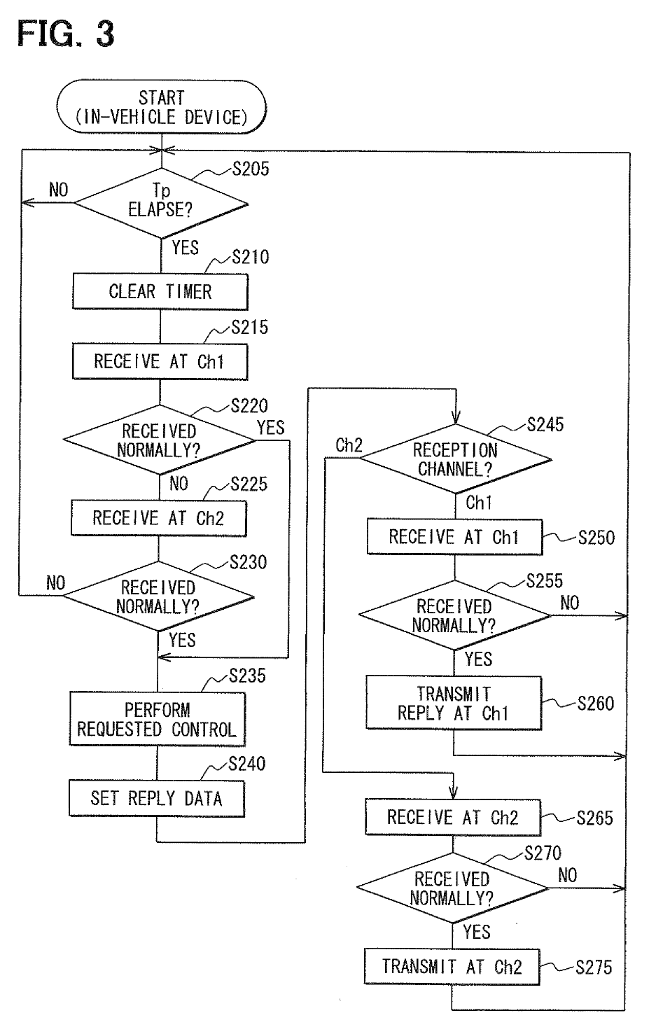

Next, the in-vehicle device processing executed by the in-vehicle device 1 when the remote keyless entry function or the remote engine start function is utilized will be described with reference to FIG. 3. The in-vehicle device processing is the processing which is executed at all times by the in-vehicle device 1.

When the in-vehicle device processing is started, the in-vehicle device 1 waits until a predetermined standby time Tp elapses (S205: NO). When the predetermined time Tp elapses (S205: YES), the timer is cleared (S210) to reset the lapse time as a check target in the processing of S205.

Subsequently, the reception of the control request signal at Ch1 is tried (S215). When the control request signal cannot be received at Ch1 (S220: NO), the reception of the control request signal at Ch2 is tried (S225). When the control request signal cannot be received at Ch2 (S230: NO), the processing returns to the processing of S205.

By the loop processing of S205 to S230, waiting→reception trial at Ch1→reception trial at Ch2→waiting, . . . , are repeated. The reception trial period at Ch1, Ch2 is set to the requisite minimum time within a time range in which it can be checked whether the control request signal arrives. When the control request signal does not arrive within the requisite minimum time, the reception trial is finished, and the processing shifts to a standby state. During this standby period, the UHF transceiver 12 is set to the resting state, whereby the power consumption at the in-vehicle device 1 is reduced.

Furthermore, the standby period is optimized on the basis of the relationship between the transmission period of the control request command in the processing of S105 and the transmission period of the control request command in the processing of S110. That is, as described with reference to the portable-device processing, even when the reception is started just before the in-vehicle device 1 is set to the standby state or just after the in-vehicle device 1 is set to the reception-possible state of the control request command, it can receive the control request command from the head thereof.

During the repetition of the loop processing of S205 to S230, when the control request command transmitted at Ch1 by the processing of S105 arrives and the control request command concerned is normally received (S220: YES), the processing proceeds to the processing of S235. Furthermore, when the control request command transmitted at Ch2 by the processing of Silo arrives and the control request command concerned is normally received (S230: YES), the processing proceeds to the processing S235.

The processing of S105, S110 is necessarily sequentially executed, and the control request commands of four frames per processing are transmitted. Therefore, the control request commands corresponding to four frames at Ch1 and four frames at Ch2, that is, totally eight frames are necessarily sequentially transmitted.

When the data corresponding to any one frame of the eight frames are normally received, it is checked (certified) on the basis of the ID code contained in the data in the processing of S220 or S230 whether the data concerned is the data transmitted from the portable device 2 which is paired with the in-vehicle device 1. Then, when the certification is satisfied, a positive determination is made, and the processing proceeds to the processing of S235.

In the processing of S235, the control indicated and requested by the control request command is performed (S235). Specifically, any one of the lock control of the doors, the unlock control of the doors and the start control of the engine is performed in accordance with which one of the commands Cmd1 to Cmd3 corresponds to the transmitted control request command.

When the above control is finished, reply data to be returned as a reply signal is set (S240). The content of this reply data is changed in accordance with the content of the control executed in the processing of S235.

Specifically, as described above, when the door lock control is carried out, the information indicating whether the doors could be normally locked is set. When the door unlock control is carried out, the information indicating whether the doors could be normally unlocked is set. Furthermore, when the engine start control is carried out, the information indicating whether the engine could be normally started, the fuel remaining amount, the vehicle interior temperature, the vehicle exterior temperature, the rainfall information, etc. are set.

When such reply data are set, it is checked which one of Ch1 and Ch2 the channel at which the control request command was received is (S245). Here, in the case of the channel Ch1 (S245: Ch1), the reception of the reply request command at Ch1 is tried (S250). When the reply request command is normally received (S255: YES), the reply data set in the processing of S240 is transmitted to the portable device 2 as the reply signal at Ch1 (S260), and then the processing returns to the processing of S205.

On the other hand, in the case of the Ch2 in the processing of S245 (S245: Ch2), the reception of the reply request command at Ch2 is tried (S265). Then, when the reply request command is normally received (S270: YES), the reply data set in the processing of S240 is transmitted to the portable device 2 as a reply signal at Ch2 (S275), and then the processing returns to the processing of S205.

If the reply request command could not be normally received as a result of the trial of the reception of the reply request command in the processing of S250 or s265 (S255: NO, or S270: NO), the processing directly returns to the processing of S205.

In the in-vehicle device processing, when the content of the control executed in the processing of S235 is changed, the time required from the start of the control to the completion of the control and the time required to achieve the information to be returned as reply data are also changed. Therefore, the time required from the start of the processing of S235 till the completion of the processing of S240 varies in accordance with the control content.

In addition, the information to be returned as the reply data is achieved through the communication of the microcomputer 10 with another ECU, and thus the processing time is dispersed in accordance with the load condition of the other ECU which depends on the prevailing situation on each occasion. For example, the time required to obtain information is different between the case where the processing capability of the other ECU is not full (i.e., has an extra capability) and the case where the other ECU is under the busy state.

More specifically, in this embodiment, with respect to the door lock control and the door unlock control, the control content is relatively simple and the content of the reply data is simple. Therefore, the time required from the start of the processing of S235 till the completion of the processing of S240 is relatively short. On the other hand, with respect to the engine start control, the time required from the engine start time till the completion thereof is longer than the time required for the door lock and unlock, and further various information is acquired as the reply data, so that the time required from the start of the processing of S235 till the completion of the processing of S240 is relatively long.

Therefore, in the portable device processing described above, by variably setting the retry times R in the processing of S115, the retry is not excessively repeated with respect to the door lock control and the door unlock control which are performed in a relatively short time. On the other hand, the retry is sufficiently repeated with respect to the engine start control which may be performed in a relatively long time.

In the processing of S125, with respect to the door lock control and the door unlock control which require a relatively short time, the standby time is set to be relatively short to receive a reply in a short time. On the other hand, with respect to the engine start control which may require a relatively long time, the standby time is set to be relatively long so that the reply request signal is restricted from being unnecessarily transmitted at the time point when the start of the engine is not completed.

By variably setting the retry times and the standby time as described above, both rapid reply and suppression of wasteful power consumption can be made compatible with each other in accordance with the control content and improved.

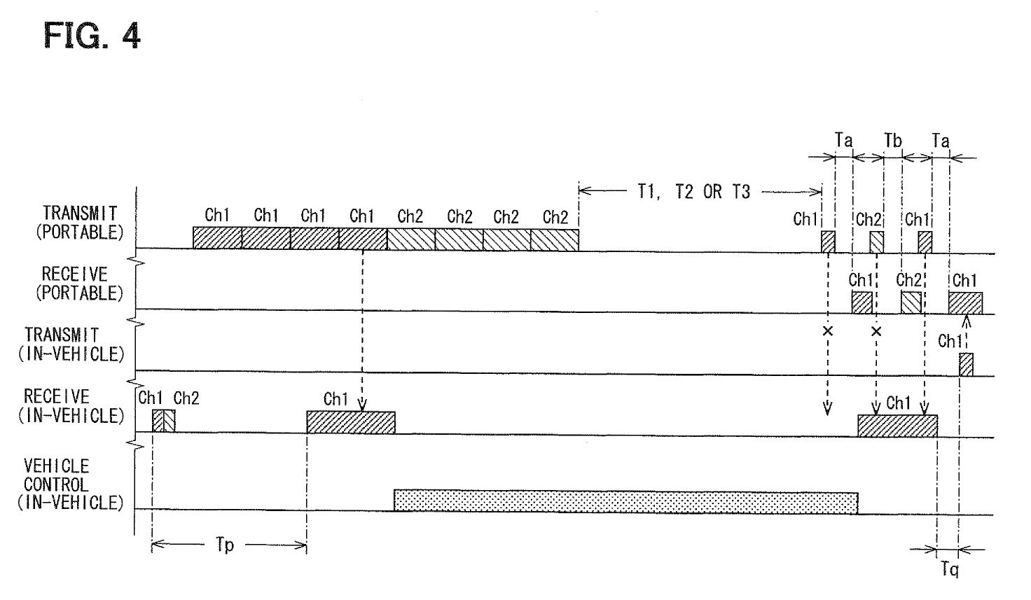

Next, an example of the communication state when the processing at the in-vehicle device 1 and the processing at the portable device 2 are executed will be described with reference to FIG. 4.

The in-vehicle device 1 repeats the loop processing of S205 to S230 at all times to try the reception of the control request command at Ch1 and Ch2 at an approximately fixed intermittent period Tp (FIG. 4: receive by in-vehicle device). When a user operates the push switch 25, 26 of the portable device 2 under such a condition, the control request commands of four frames at Ch1 and four frames at Ch2, totally eight frames are sequentially transmitted from the portable device 2 in the processing of S105, S110 (FIG. 4: transmit by portable device).

With respect to the control request commands of the eight frames, at least one frame is detected at the reception trial time of the in-vehicle device 1 (at the execution time of the processing of S215 to S230). In the case of the example shown in FIG. 4, the transmission at Ch1 by the portable device 2 (S105) has been already started at the start time of the reception trial at Ch1 by the in-vehicle device 1 (at the execution time of the processing of S215).

Therefore, the in-vehicle device 1 starts to receive the control request command in the middle of the third frame from the head. However, the in-vehicle device 1 continues to receive the control request command with no operation, whereby it receives the control request command of one frame at the fourth frame from the head till the last.

The bit train (frame data) itself as the control request command is completely identical between Ch1 and Ch2. Accordingly, even when the channel being used is changed, it is unnecessary to deal with data in the processing (for example, the processing of extracting data of one frame, the processing of correcting an error or the like) to handle the bit train (frame data) at both the in-vehicle device 1 and the portable device 2 while discriminating the data transmitted and received at Ch1 and the data transmitted and received at Ch2.

When the control request command of one frame is received as described above, the in-vehicle device 1 executes the control corresponding to the control request command in the processing of S235 (FIG. 4: vehicle control by in-vehicle device). On the other hand, the portable device 2 waits by only the standby time corresponding to the transmitted control request command (any one of T1 to T3) in the processing of S125. The standby time T1 to T3 are set in consideration of the time period required for the control at the in-vehicle device 1, and thus the reply request command can be prevented from being needlessly transmitted during this period.

After the standby time T1 to T3 elapses, the portable device 2 is set to a state that it repeats the reply request command transmission and the reply reception at Ch1 and the reply request command transmission and the reply reception at Ch2 in the processing of S130 to S175. Since the control is completely substantially at the same time point in the in-vehicle device 1, the reception of the reply request command is tried in the processing of S250 or the processing of S260.

The time point at which the portable device 2 starts to transmit the reply request command and the time point at which the in-vehicle device 1 starts reception trial of the reply request command are not strictly coincident with each other. Therefore, in the case shown in FIG. 4, for example, the portable device 2 starts to transmit the reply request command at Ch1 at the stage that the control at the in-vehicle device 1 has not been completed. In this case, the reply request command is not received at the in-vehicle amount device 1 (mark X in FIG. 4).

Furthermore, when the control at the in-vehicle device 1 is completed, the in-vehicle device 1 tries to receive the reply request command by using the channel used when receiving the control request command. In the case shown in FIG. 4, the control request command is received at Ch1, and thus the reception of the reply request command is tried at Ch1.

Therefore, even when the portable device 2 is set to the state that it repeats the reply request command transmission and the reply reception at Ch1 and the reply request command transmission and the reply reception at Ch2, the reply request command transmitted Ch2 is not received at the in-vehicle device 1 (mark of X in FIG. 4).

On the other hand, the reply request command transmitted at Ch1 is received at the in-vehicle device 1. With the reception of this reply request command as a trigger, the in-vehicle device 1 returns the reply to the portable device 2 in the processing of S260 or S275. In the case shown in FIG. 4, the reply is returned at Ch1 in the processing of S260.

In the case shown in FIG. 4, a time Tq is required till the reply transmission at Ch1 is actually started after the reception processing (S250 to S255) at the in-vehicle device 1 is completed. Therefore, the standby time Ta in the processing of S135 is set in consideration of the time Tq, and the timing at which the reply is transmitted and received is optimized after the reply request command is transmitted and received.

However, in the above case, the standby time Ta is provided at the portable device 2. However, if the processing at the portable device 2 requires a time, the standby time may be provided at the in-vehicle device 1. If both the portable device and the in-vehicle device have the capability of executing the transmission and reception processing in a short time, the standby time may be eliminated from them.

According to the vehicle remote control system constructed with the in-vehicle device 1 and the portable device 2, in consideration of the time required for the vehicle control by the in-vehicle device 1, the portable device 2 can transmit the reply request signal after a sufficient standby time T1 to T3 elapses, and then receive the reply from the in-vehicle device in a short time.

Accordingly, it is unnecessary for the portable device 2 to continue to wait for a reply to which a return time from the in-vehicle device is unclear. The power consumption at the portable device 2 can thus be reduced, and the portable device 2 can secure a time to spare for execution of various kinds of processing before receiving information from the in-vehicle device.

Specifically, the UHF transmitter 22 and the UHF receiver 23 of the portable device 2 may rest during the processing of S125, and may be made active when the processing goes through the processing of S125. This reduces the power consumption of the portable device 2. In addition to the reduction of the power consumption of the portable device 2, another processing may be executed during the processing of S125, if necessary.

The UHF transmitter 22 and the UHF receiver 23 of the portable device 2 can rest because it is guaranteed that no reply is returned from the in-vehicle device 1 during the resting period. That is, the in-vehicle device 1 cannot return the reply even when the control is completed unless the portable device 2 transmits the reply request command. Therefore, the portable device 2 can secure the resting period with no problem, and it can suppress power consumption and execute other processing.

Furthermore, if the vehicle remote control system is constructed so that the reply is returned from the in-vehicle device 1 to the portable device 2 with the transmission of the reply request command from the portable device 2 as a trigger, even when data of a short data length of several bits such as “ACK (acknowledgement)” or the like is transmitted, the data can be surely received without being partially lost and without needlessly consuming power for a very short reception period.

Here, as a method of surely transmitting short data may be used a method in which the transmission side continues to repetitively transmit the short data and the reception side receives the data when the reception side is set to an active state.

A method in which the reception side continues to set the reception circuit to be active, and the short data is received when the data is transmitted, may be used.

However, it is not desired that the transmission side continues to repetitively transmit short data from the viewpoint of the use efficiency of electric waves. Furthermore, when it is considered that the reply from the in-vehicle device 1 to the portable device 2 is transmitted, it is problematic that the portable device 2 serving as the reception side continues to make the reception circuit active for a long term, because the period of unnecessarily consuming power is lengthened. Furthermore, when data reception is tried while switching two channels to each other as in the case of this embodiment, short data may come in the act of switching the channel, and in this case the data reception may fail. Still furthermore, short data may come at a channel different from the channel being used, and in this case the data reception may fail.

In this sense, if the vehicle remote control system is constructed so that with the transmission of the reply request command from the portable device 2 as a trigger, the reply is returned from the in-vehicle device 1 to the portable device 2 by using the channel at the transmission time of the reply request command as the trigger, the channel being used can be made coincident between the in-vehicle device 1 and the portable device 2 although the portable device 2 does not recognize which one of the channels is used at the in-vehicle device 1.

In addition, the timing at which the reply is turned can be approximately synchronized. Therefore, it is unnecessary to wait for an excessively long time until data comes, and even when the portable device 2 has only a compact power supply such as a button battery, the lifetime of the button battery can be extended. Furthermore, even when the data length is short, the data can be surely received.

Furthermore, in the vehicle remote control system, the standby time T1 to T3 until the reply request signal is transmitted is varied in accordance with which one of the control request commands Cmd1 to Cmd3 is transmitted. Accordingly, with respect to the control which is completed in a relatively short time (for example, the lock and unlock of doors), the response performance can enhanced by setting the standby times T1, T2 to short values respectively in advance. Furthermore, with respect to the control which requires a relatively long time (for example, the engine start control), the power consumption can be suppressed and the time required to execute other processing can be secured by setting the standby time T3 to a long value in advance.

In the vehicle remote control system described above, when it is judged in the processing of S145, S165 that the reception of the reply signal fails, the transmission of the reply request signal and the reception of the reply signal are retried in the processing of S175. Accordingly, even when the first reception of the reply signal fails due to some cause, the probability that the reply signal can be received can be increased by second or subsequent retrial.

In addition, when this retrial is made, the retrial frequency R1 to R3 varies in accordance with which one of the control request commands Cmd1 to Cmd3 is transmitted.

Accordingly, with respect to the control in which the variation of the time required from the control is started till the control is completed is relatively small (for example, the door lock and unlock), the retrial frequency R1, R2 is set to a relatively small value, whereby the needless retrial can be prevented from being excessively repeated. On the other hand, with respect to the control in which the dispersion of the time required from the start of the control till the completion of the control is relatively large (for example, the engine start control), the retrial frequency R3 is set to a relatively large value, whereby the reception of the reply signal can be prevented from being easily given up when the completion of the control is late.

How many times the retrial is made may be optimized in consideration of the time required from the start of the control till the completion of the control, the time required for the transmission and reception of the reply request command and the transmission and reception of the reply, the repetitive interval upon repeating the retrial, the required response, etc.

For example, in order to suppress the power consumption, the standby time in the repetitive processing may be set to be long, and in this case, the repetitive frequency per unit time is reduced. Furthermore, if the standby time in the repetitive processing is set to be short, the repetitive frequency per unit time can be increased, so that the number of times of trial of the transmission and reception is enhanced, and the response performance can be enhanced. However, this causes the power to be easily consumed, and thus it is preferable that the repetitive period can be optimized within a range in which increase of power consumption is permitted.

Furthermore, in the vehicle remote control system described above, the in-vehicle device 1 and the portable device 2 transmit and receive the control request signal, the reply request signal and the reply signal by using the two channels. Accordingly, for example even when any one of the two channels suffer interference, the channel being used is switched to the other channel, and then the transmission of the reply request signal and the reception of the reply signal can be performed. Accordingly even when the reception of the reply signal at one channel fails due to some cause, the probability that the reply signal can be received can be enhanced by retrial at the other channel.

The present invention is not limited to the above embodiment, and various modifications may be made without departing from the subject matter of the present invention.

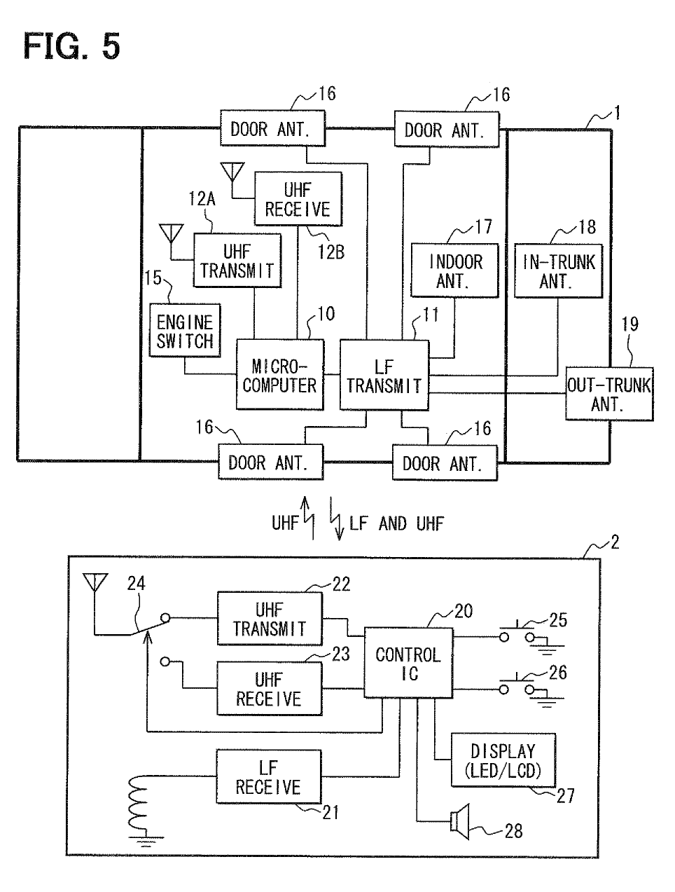

For example, in place of the UHF transceiver 12, a UHF transmitter 12A and a UHF receiver 12B may be connected to the microcomputer 10 as shown in FIG. 5.

By adopting the above construction, with respect to the UHF receiver 12B, a device which is normally equipped in a vehicle for a passive entry system is used as the UHF receiver 12B, and only the UHF transmitter 12A is afterwards equipped as a dealer option. That is, in the case of a vehicle equipped with a passive entry system, the LF transmitter 11 and the UHF receiver 12B are normally equipped. Accordingly, if this UHF receiver 12B is used, the construction corresponding to the UHF transceiver 12 can be equipped by merely adding the UHF transmitter 12A.

Furthermore, it may be freely determined whether the passive entry system is mounted or not. In the case of the system having no passive entry system mounted therein, the in-vehicle device 1 may be equipped with neither LF transmitter 11 nor antenna group for LF transmission. The portable device 2 may be equipped with no LF receiver 21.

Furthermore, the system having any one of these functions may be used or the system further having other function may be used.

Still furthermore, the control target is not limited to the door lock, the door unlock an the engine start.

For example, the display function of the fuel remaining amount, the vehicle interior temperature, the vehicle exterior temperature, the rainfall information, etc. may be handled as an independent control target. In this case, by carrying out a predetermined operation through the push switch 25, 26 of the portable device 2, only information may be displayed at the portable device 2.

The control result need not be displayed on the display unit 27, but it may be reported by a buzzer 28. One of the display unit 27 and the buzzer 28 may be selectively used in accordance with the control target. For example, the door lock and unlock may be reported by the buzzer 28, and the engine start may be reported by the display unit 27. The user may freely set which one of the buzzer 28 and the display unit should be used.

The in-vehicle device 1 and the portable device 2 may communicate with each other by using three or more channels. If the number of channels is increased, the probability that all the channels suffer interference is lower. However, a hardware which can use a larger number of channels is required, and unnecessary increase of the number of channels causes a demerit in cost. Therefore, from the viewpoint of the cost effect and easiness of control, it is preferable to use two channels as in the case of this embodiment.

Furthermore, the frequency band to be used is arbitrarily determined. However, in consideration of the scale of the device structure, the power consumption and the arrival distance of electric waves, it is preferable to use the UHF band channel as in the case of this embodiment.

The control request signal and the reply request signal need not be transmitted in sequence with a predetermined period therebetween, but they may be transmitted at the same time.

Still further, the above embodiment may be adapted to home, office, and the like.

What is claimed is:

1. A remote control system comprising an in-vehicle device mounted in a vehicle and a portable device carried by a user for communication with the in-vehicle device,
the portable device is configured to include:
control request transmitting means for transmitting a control request signal corresponding to an operation of a user;
reply request transmitting means for transmitting a reply request signal; and
reporting means for reporting information concerning an execution result of predetermined control executed by the in-vehicle device in response to the control request signal, the information being reported in response to the reply request signal, and
the in-vehicle device is configured to include:
control request receiving means for receiving the control request signal from the portable device;
control means for executing the predetermined control corresponding to the control request signal; and
reply request receiving means for receiving the reply request signal,
wherein the portable device further includes reply receiving means for receiving a reply signal transmitted from the in-vehicle device when a reception time point determined in accordance with a transmission time point of the reply request signal arrives after the reply request signal is transmitted; and
the in-vehicle device further includes reply transmitting means for transmitting the information concerning the execution result of the predetermined control as the reply signal when a transmission time point determined in accordance with a reception time point of the reply request signal arrives after the reply request signal is received.

2. The remote control system according to claim 1, wherein:
the reply request transmitting means is configured to transmit the reply request signal when a predetermined standby time elapses after the control request signal is transmitted; and
the portable device is configured to be set to a power saving state, in which power consumption is less than under a reception-possible state in which the reply receiving means is enabled to receive the reply signal, until the standby time elapses after the control request signal is transmitted.

3. The remote control system according to claim 1, wherein:
in the portable device, the control request transmitting means is configured, when the user carries out any one of plural operations, to select a kind of control request signal corresponding to the operation carried out by the user from plural kinds of control request signals, and to transmit the selected one kind of control request signal, and the reply request transmitting means is configured to select one standby time corresponding to the operation carried out by the user from plural standby times after the control request signal is transmitted, and to transmit the reply request signal when the selected one standby time elapses; and
in the in-vehicle device, the control means is configured to select one kind of control corresponding to the control request signal from plural kinds of control, and to execute the selected one kind of control.

4. The remote control system according to claim 1, wherein:
the portable device is configured to check whether the reception of the reply signal by the reply receiving means succeeds or fails; and
the portable device is configured to retry transmission of the reply request signal and reception of the reply signal, when the reception of the reply signal fails.

5. The remote control system according to claim 4, wherein:
the portable device is configured to select a retry number of times from a plurality of predetermined retry number of times when transmission of the reply request signal and reception of the reply signal are retried;
the portable device is configured to select one kind of control request signal corresponding to the operation carried out by the user from plural kinds of control request signals and transmit the selected one kind of control request signal to the in-vehicle device when the user carries out any one of plural operations; and
the portable device is configured to select one retry number of times corresponding to the operation carried by the user from the plural retry number of times.

6. The remote control system according to claim 4, wherein:
the portable device and the in-vehicle device are configured to communicate with each other by using plural channels of different frequencies;
the portable device is configured to transmit the control request signal by using the plural channels, to transmit the reply request signal by using one channel selected from the plural channels, and to receive the reply signal by using the same channel as the reply request signal; and
the portable device is configured, when reception of the reply signal fails, to change the channel being used to another channel, and then to retry transmission of the reply request signal and reception of the reply signal.

7. The remote control system according to claim 6, wherein:
the plural channels are defined by different frequencies in a UHF band.

8. The remote control system according to claim 6, wherein:
the plural channels are two channels.

9. A remote control method for remotely controlling a control object through communication between a fixed device fixedly mounted in the control object and a portable device carried by a user, the method comprising:
transmitting, from the portable device, a control request signal corresponding to an operation of a user on the portable device and a reply request signal;
receiving, by the fixed device, the control request signal and the replay request signal;
executing predetermined control of the control object by the fixed device in response to a received control request signal;
transmitting, from the fixed device, a reply signal indicating a result of the predetermined control in response to a received reply request signal;
receiving, by the portable device, the reply signal; and
notifying, by the portable device, the result of the predetermined control indicated by a received reply signal,
wherein the remote control method further comprises:
delaying transmission of the reply request signal for a predetermined time after transmission of the control request signal by the portable device, and
holding the portable device in a power saving state for the predetermined time after transmission of the control request signal.

10. The remote control method according to claim 9, wherein:
the predetermined time is set variably in accordance with contents of the predetermined control.
